(19) United States
(12) Patent Application Publication
(10) Pub. No.: US 2006/0124116 A1
(43) Pub. Date: Jun. 15, 2006

(54) Clean gas injector

(76) Inventor: Yung T. Bui, Peoria, IL (US)

Correspondence Address: CATERPILLAR INC.;100 N.E. ADAMS STREET, PATENT DEPT., PEORIA, IL, 616296490, US

(21) Appl. No.: 11/012,458

(22) Filed: Dec. 15, 2004

(51) Int. Cl. F02M 25/07

(52) U.S. Cl. 123/568.18; 123/568.12; 60/278

(57) ABSTRACT

A clean gas induction (CGI) injector having an intake air conduit with inner diameter and defining an intake air flow path, and a CGI conduit defining a clean gas flow path. The CGI conduit disposed within the intake air conduit includes an open end portion having an inner surface and an outer surface. The outer surface, having a substantially less diameter than the inner diameter of the intake air conduit, is formed to restrict the intake air flow.

### TECHNICAL FIELD

This invention relates to the field of clean gas induction (CGI) systems of an internal combustion engine, and, more particularly, to a CGI injector for introducing clean gases into the intake of a turbocharged internal combustion engine upstream of a compressor.

### BACKGROUND

An exhaust gas recirculation (EGR) system is used for controlling the generation of undesirable pollutant gases and particulate matter in the operation of internal combustion engines. Such systems have proven particularly useful in internal combustion engines for motor vehicles such as passenger cars, light duty trucks, and other on-road motor equipment. EGR systems primarily recirculate the exhaust gas by-products into the intake air supply of the internal combustion engine. The exhaust gas which is reintroduced into the internal combustion engine cylinder reduces the concentration of oxygen therein, which, in turn, lowers the maximum combustion temperature within the cylinder and slows the chemical reaction of the combustion process, decreasing the formation of nitrous oxides (NOₓ). Furthermore, exhaust gases that are reintroduced into the internal combustion engine typically contain unburned hydrocarbons that are burned to further reduce the emission of exhaust gas by-products that otherwise would be emitted as undesirable pollutants from the internal combustion engine.

When utilizing EGR in a turbocharged diesel engine, the exhaust gas to be recirculated is typically removed upstream of the exhaust gas driven turbine associated with the turbocharger. For example, in many EGR applications the exhaust gas is diverted directly via an EGR conduit from the exhaust manifold to the intake system. Likewise, the recirculated exhaust gas may be re-introduced to the intake air stream downstream of the compressor and inter-cooler or air-to-air aftercooler.

At many operating conditions of a turbocharged diesel engine, there is a pressure differential between the intake manifold and the exhaust manifold which essentially prevents many such simple EGR systems from being utilized. For example, at low speed and/or high load operating conditions in a turbocharged engine, the exhaust gas does not readily flow from the exhaust manifold to the intake manifold. Therefore, many EGR systems include an EGR driver such as a Roots-type blower or an auxiliary compressor to force the exhaust gas from the exhaust manifold to the higher pressure intake manifold. U.S. Pat. No. 5,657,630 (Kjemtrup et al.) issued on Aug. 19, 1997 is merely one example of the many EGR systems that utilize a pump or blower type arrangement to drive the CGI from the exhaust manifold to the intake system. European Patent No. EP 0 889 226 B1 published Aug. 8, 2001 as well as PCT patent document WO 98/39563 published Sep. 11, 1998 disclose the use of an auxiliary compressor wheel driven by the exhaust gas driven turbine associated with the turbocharged diesel engine. The auxiliary compressor wheel forcibly drives the recirculated exhaust gas from the exhaust manifold to the intake system at nearly all engine operating conditions.

One apparent problem with such forced EGR systems that utilize an auxiliary compressor is that the auxiliary compressor chokes long before the EGR flow requirements are met at many light load operating conditions. Such light loads yield conditions where the exhaust manifold pressure and the auxiliary compressor, blower, pump or other EGR driver is more of a flow restriction than an assist.

It may be preferred to reintroduce exhaust gases upstream of the compressor, such as by a low pressure loop system disclosed in U.S. Pat. No. 6,651,618 (Coleman et al.) issued on Nov. 25, 2003. Coleman discloses a low pressure EGR system that utilizes a throttle valve to control air and recirculated gases being delivered to the engine and an EGR valve to control the amount of exhaust gases that are being reintroduced into the intake air. Because exhaust gases are at a higher pressure than intake air in a low pressure EGR systems, the need for the aforementioned blower or compressor in the commonly used high pressure EGR system is eliminated. One apparent problem with the utilization of the throttle valve is the inefficiency caused from airflow restriction resulting from the throttle valve. Such a restriction increases the pressure and airflow loss, which may lead to choking the engine. This may result in a decrease in the fuel economy of the internal combustion engine. The performance of the EGR system is based on how much exhaust gas it can draw into the engine with minimal airflow and pressure loss. In addition, the reliability and durability of such a throttle valve is suspect to failures due to the mechanical nature of such devices. This does, however, require a means of injecting the exhaust gases into the intake.

The present invention is directed to overcoming one or more of the problems as set forth above.

### SUMMARY IF THE INVENTION

According to one exemplary aspect of the present invention a clean gas induction (CGI) injector is disclosed. The injector includes an intake air conduit having an inner diameter and defining an intake air flow path. The injector further includes a CGI conduit disposed within the intake air conduit defining a clean gas flow path. The CGI further includes an open end portion having an inner surface and an outer surface. The outer surface having a substantially less diameter than the inner diameter of the intake air conduit and the open end portion being formed to restrict the intake air flow.

According to another exemplary aspect of the present invention an internal combustion engine is disclosed having an engine block defining a plurality of combustion chambers. The engine includes an exhaust air system having an exhaust air conduit and in fluid communication with the plurality of combustion chambers. In addition, the engine further includes an intake air system having an intake air conduit defining a intake air flow path and in fluid communication with the plurality of combustion chambers, and an intake air compressing device. Further, the engine includes a CGI system extending between the exhaust air system and the intake air system. The CGI system is connected to the intake air system upstream of the intake air compressing device and includes a CGI injector having a CGI injector valve and an CGI conduit defining a clean gas flow path. The CGI conduit includes an open end portion disposed within the intake air conduit, and an inner surface and an outer surface. The outer surface has a substantially less diameter than the inner diameter of the intake air conduit and the open end portion is formed to restrict the intake air flow. The engine includes an ECM operatively coupled to the internal combustion engine.

It is to be understood that both the foregoing and general description and the following detailed description are exemplary and explanatory only and are not restrictive of the invention.

### BRIEF DESCRIPTION OF THE DRAWINGS

FIG. 1 depicts a diagrammatic view of an internal combustion engine incorporating the clean gas induction system of the present invention; and

FIG. 2 depicts a perspective view of an embodiment of the present invention clean gas injector.

### DETAILED DESCRIPTION

The following description is of the best mode presently contemplated for carrying out the invention.

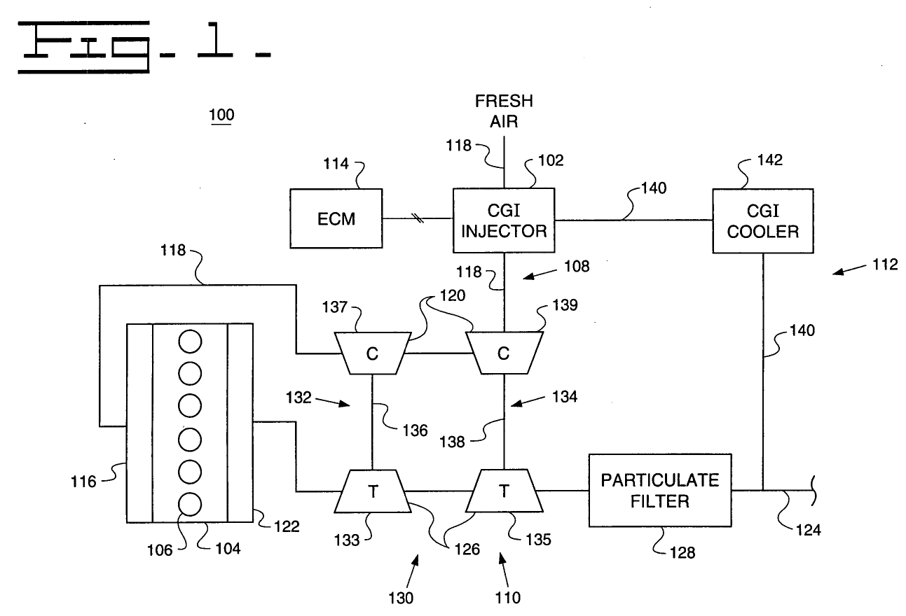

Referring to FIG. 1, there is shown a diagrammatical view of an exemplary internal combustion engine 100 having the embodiment of a clean gas induction (CGI) injector 102 of the present invention. For purposes of illustration and not limitation the internal combustion engine 100, hereinafter known as the engine 100, is that of a four-stroke, diesel engine. The engine 100 includes an engine block 104 defining a plurality of combustion chambers 106, the number of which depends on the particular application. In the exemplary engine 100, six combustion chambers 106 are shown, however, it should be appreciated that any number of combustion chambers may be applicable with the present invention. Although not shown, there may be associated with each combustion chamber 106: a fuel injector, a cylinder liner, at least one air intake port and corresponding intake valve, at least one exhaust gas port and corresponding exhaust valve, and a reciprocating piston moveable within each combustion cylinder to define, in conjunction with the cylinder liner and cylinder head, the combustion chamber. The illustrated engine 100 includes an intake air system 108, an exhaust air system 110, a CGI system 112, and an engine control module 114 (ECM).

The intake air system 108 includes an intake manifold 116 removably connectable and in fluid communication with the engine 100, an intake air conduit 1 18 capable of carrying intake air to the intake manifold 1 16, and a intake air compressing device 120 in fluid communication with the intake air conduit 118. The intake air compressing device 120 could be, but not limited to, a traditional turbocharger known in the art, an electric turbocharger, a supercharger, or the like. The intake manifold 116 is shown as a single-part construction for simplicity, however, it should be appreciated that the intake manifold 116 may comprise multiple parts, depending upon the particular application. Further, the intake air system 108 may include an intercooler or an air-to-air aftercooler in fluid communication thereto, not presently shown.

The exhaust air system 1 10, as shown, includes an exhaust manifold 122 removably connectable, and in fluid communication, with the engine 100, an exhaust air conduit 124 capable of carrying exhaust gas from the exhaust manifold 122, an air compressing device drive 126 in fluid communication with the exhaust air conduit 124, and a particulate matter (PM) filter 128 in fluid communication with the exhaust air conduit 124. The exhaust manifold 122 is shown as a single-part construction for simplicity; however, it should be appreciated that the exhaust manifold 122 may be constructed as multi- part or split manifolds, depending upon the particular application.

The intake air compressing device 120 and air compressing device drive 126 are illustrated as part of a turbocharger system 130. The turbocharger system 130 shown is a first turbocharger 132 and may include a second turbocharger 134. The first and second turbochargers 132, 134 may be arranged in series with one another such that the second turbocharger 134 provides a first stage of pressurization and the first turbocharger 132 provides a second stage of pressurization. For example, the second turbocharger 134 may be a low-pressure turbocharger and the first turbocharger 132 may be a high-pressure turbocharger. Each of the first and second turbochargers 132, 134 includes a turbine 133, 135, respectively and a compressor 137, 139, respectively. The turbines 133, 135 are fluidly connected to the exhaust manifold 122 via exhaust air conduit 124. Each of the turbines 133, 135 includes a turbine wheel (not shown) carried by a shaft 136, 138, respectively, which in turn may be rotatably carried by a housing (not shown), for example, a single-part or multi-part housing. The fluid flow path from the exhaust manifold 122 to the turbines 133, 135 may include a variable nozzle (not shown) or other variable geometry arrangement adapted to control the velocity of exhaust fluid impinging on the turbine wheel.

The compressors 137, 139 include a compressor wheel (not shown) carried by the shafts 136, 138. Thus, rotation of the shafts 136, 138 by the turbine wheel, in turn, may cause rotation of the compressor wheel.

The CGI system 112, as shown, is a low pressure CGI system of an internal combustion engine 100, wherein a portion of exhaust gases are filtrated by the PM filter 128 and cooled by a CGI cooler 142, to produce clean and cooled gas, before being injected upstream of the intake air compressing device 120. The CGI system 112 includes a CGI conduit 140 that extends between the exhaust air system 110 and intake air system 108 and is capable of carrying the portion of exhaust gases from the exhaust system 110 to the intake system 108. The CGI cooler 142 is in fluid communication with the CGI conduit 140 and may be located between the exhaust air system 110 and the intake air system 108. A CGI injector 102 is in fluid communication with, and is located between, the CGI conduit 140 and the intake air conduit 118. As is well known in the CGI art, the CGI cooler 142 may include an air to gas cooler, a water to gas cooler, an oil to gas cooler, or any other suitable cooler properly sized to provide the necessary CGI cooling. The CGI system 112 may include a soot filter (not shown) in fluid communication with the CGI conduit 140.

The exhaust air conduit 124 discharges exhaust gases externally downstream of the PM filter 128. However, the portion of exhaust gases are rerouted to the intake manifold 116 via the CGI conduit 140 and CGI injector 102. As shown, the exhaust gases for the CGI system 112 are extracted from the exhaust air conduit 124 downstream of the PM filter 128, however, it should be appreciated that the exhaust gases may be extracted from anywhere in the exhaust air system 110, such as the PM filter 128, first or second turbochargers 132, 134, or the exhaust manifold 122.

Finally, the ECM operatively coupled to the internal combustion engine 100 and capable of operatively controlling, but not limited to; the fuel injection timing, the intake air system 108, the exhaust air system 110, and the CGI system 112. All such engine system controlled operations are governed by the ECM 114 in response to one or more measured or sensed engine operating parameters, which are typically inputs (not shown) to the ECM 114.

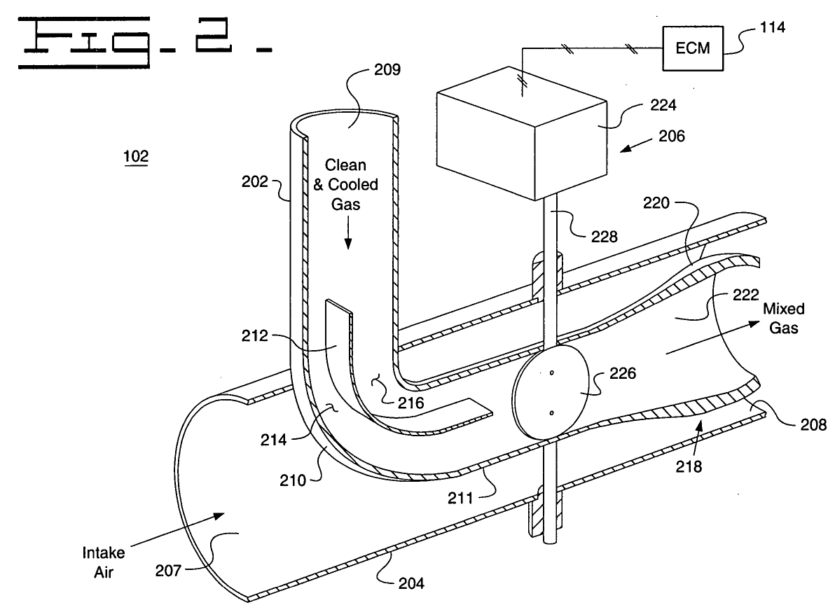

Turning now to FIG. 2, a perspective view of the CGI injector 102 is shown. The CGI injector 102 includes a CGI injector valve 206 and is connected with the CGI conduit 140 (FIG. 1) at a CGI conduit portion 202. Further, the CGI injector 102 is connected with the intake air conduit 118 (FIG. 1) at an intake air conduit portion 204.

The CGI injector 102 is used to inject clean and cooled gas from the CGI system 112 into the intake air system 108. The intake air conduit portion 204 includes a first portion 207, which defines an intake air flow path, and a second portion 208, which defines a mixed fluid flow path that includes clean and cooled gas and intake air, wherein the clean and cooled gas has substantially higher fluid pressure than the intake air.

The CGI conduit portion 202, defining a clean and cooled gas flow path, intersects, and is disposed within, the intake air conduit portion 204 at an intermediate portion. It should be appreciated that the CGI conduit portion 202 has an outer diameter that is substantially less than the inner diameter of the intake air conduit portion 204. As illustrated in the embodiment shown, the CGI conduit portion 202 includes a first portion 209, a bent portion 210, and a second portion 211, such that when positioned inside the intake air conduit portion 204, the second portion 211 expels clean and cooled gas into the intake air conduit portion 204. The bent portion 210 may include a turning vane 212, structured and arranged to divide the clean and cooled gas flow into a first flow path 214 and a second flow path 216.

The second portion 21 lof the CGI conduit portion 202 defines an open end portion 218. An outer surface 220 of the open end portion 218 is formed to restrict the intake air flow in the intake air conduit portion 204. In the embodiment shown, the outer surface is formed to have a variable increasing outer diameter that is less than the inner diameter of the intake air conduit portion 204. For example, the variable increasing diameter is shown as substantially a bell mouth shape, however, it should be appreciated that other shapes such as conical, elliptical, “L” shape, or other suitable shapes may be used. It should be contemplated that the outer surface 220 may be formed by means well known in the art for forming a variable increasing diameter shape, including but not limited to, machining, casting, forging, or the like.

In the embodiment shown an inner surface 222 of the open end portion 218 is formed to have a conical shape extending from the second portion 211. However, it should be appreciated that the inner surface 222 may be formed to have a substantially constant diameter, a variable diameter, or be formed to coincide with the outer surface 220, to maintain a constant wall thickness of the open end portion 218. It should be contemplated that the inner surface 222 may be formed by means well known in the art for forming the inner surface 222, including, but not limited to, machining, casting, forging, or the like

The CGI injector valve 206 shown is structured and arranged in the CGI conduit portion 202 such that the valve 206 may be variably positioned between open and closed position to control the amount of gas that enters the intake air system 108. In the embodiment shown, the open position allows the maximum clean gas to enter the intake air system 108, and the closed position allows the minimal clean gas to enter the intake air system 108. The CGI injector valve 206 includes an actuating device 224 connected with the ECM 114 and a bypass member 226 connectable to the actuating device 224. The bypass member 226 is positioned concentrically within the CGI conduit portion 202 at the second portion 211. In the embodiment shown, the bypass member 226 is a butterfly type valve, which is positioned by a pivotal shaft 228 connected to the actuating device 224. However, it should be contemplated that other valves such as ball valves, beak valves, spring valves, linear valves, pressure compensated valves or the like may be used. The ECM 114 actuates the shaft 228 through the actuating device 224, which selectively opens and closes the bypass member 226 to control the amount of clean gas that enters the intake air system 108. In addition, the CGI injector valve 206 may be located anywhere in the CGI system 112 as to not change or alter the present invention.

The ECM 114 controllably actuates the bypass member 214 using selected internal combustion engine operating parameters received from sensor signals (not shown), such as engine load, intake manifold pressure, engine temperature, PM filter pressure, or exhaust manifold pressure. The ECM 114 may be configured to carry out the control logic using software, hardware, and means known in the art to perform logics and execute commands.

### INDUSTRIAL APPLICABILITY

During operation of the engine 100, combustion occurs, which produces exhaust gas captured by the exhaust manifold 122. The exhaust gas is transported via exhaust air conduit 124 to the turbochargers 132, 134. The turbines 133, 135 within the turbochargers 132, 134 rotatably drives the compressors 137, 139 of the turbochargers 132, 134, which compresses intake air and outputs the compressed air to the engine 100 via the intake air conduit 118. The exhaust gas expelled out of the turbines 133, 135 is transported to the particulate matter (PM) filter 128 where the soot from the exhaust gas is trapped or otherwise removed from the exhaust gas. The gas expelled out of the PM filter 128 is clean gas. A portion of the clean gas is delivered out of the exhaust air system 110 via the exhaust air conduit 124; however, a portion of the clean gas is extracted from the exhaust air conduit 124 and rerouted through the CGI system 112.

The clean gas in the CGI system 112 is transported to the CGI cooler 142 where the hot clean gas is cooled to provide clean and cooled gas. The clean and cooled gas is then carried to the CGI injector 102 via the CGI conduit 140, where the CGI injector 102 is in fluid communication with the CGI conduit 140 and intake air conduit 118.

Intake air is routed through the first portion 207 of the intake air conduit portion 204. As the intake air flows through the intake air conduit portion 204 it impinges the outer surface 220 of the open end portion 218 of the conduit portion 202. Therefore, constricting the intake air and increasing the velocity of the intake air and decreasing the pressure of the intake air. The decreased pressure in the intake air results in a venturi effect, drawing the substantially higher pressured clean gas into the intake air system 108.

The clean and cooled gas flowing through the CGI conduit portion 202 and impinges on the turning vane 212. The turning vane 212 splits the clean gas flow into first and second flow paths 214,216, therefore, reducing the swirl and straightening the clean and cooled gas flow. The clean gas expels out the open end portion 218 and mixes with the intake air to provide mixed gas to the internal combustion engine 100.

The amount of clean and cooled gas being introduced is dependent upon the position of the bypass member 226, e.g., between an open and closed position. By varying the position of the bypass member 226, using the ECM 114, the amount of clean and cooled gas being introduced into the intake air system 108 can likewise be varied. The ECM 114 controllably varies the bypass member 226 indicative of selective input parameters.

The CGI injector 102 of the present invention allows clean and cooled gas to be introduced into the intake air system 108 in an efficient and controllable manner. The use of the open end portion 218 generates the pressure differential needed to draw the higher pressured clean gas into the intake air system 108 in a low-pressure loop CGI system 112. In addition, the use of a blower or compressor is not needed because there is no need to overcome the higher pressured compressed air in a CGI high-pressure loop.

Other aspects of the present invention may be obtained from study of the drawings, the disclosure, and the appended claims. It is intended that that the specification and examples be considered exemplary only.

What is claimed is:

1. A clean gas induction (CGI) injector, comprising:
an intake air conduit defining an intake air flow path, the intake air conduit having an inner diameter; and
a CGI conduit defining a clean gas flow path, the CGI conduit being disposed within the intake air conduit, the CGI conduit includes an open end portion having an inner surface and an outer surface, the outer surface having a substantially less diameter than the inner diameter of the intake air conduit and the open end portion being formed to restrict the intake air flow.

2. The injector of claim 1, wherein the CGI conduit includes a bent portion.

3. The injector of claim 2, wherein the CGI conduit includes a turning vane disposed within the bent portion, the turning vane being positioned to divide the clean gas flow into a first flow path and a second flow path.

4. The injector of claim 1, wherein the outer surface of the open end portion has a smooth transition.

5. The injector of claim 4, wherein the smooth transition of the open end portion is substantially a bell mouth shape.

6. The injector of claim 1, wherein the inner surface of the open end portion is formed to have a varying diameter.

7. The injector of claim 1, wherein the inner surface of the open end portion is formed to maintain a constant wall thickness.

8. The injector of claim 1, further including a CGI injector valve positioned in fluid communication with the CGI conduit.

9. The injector of claim 8, wherein the CGI injector valve includes an actuating device connected to the CGI injector valve, a bypass member positioned concentrically with the CGI conduit and a shaft connecting the actuating device and the bypass member.

10. The injector of claim 9, wherein the bypass member is a butterfly valve.

11. An internal combustion engine, the engine includes an engine block defining a plurality of combustion chambers, comprising:
an exhaust air system in fluid communication with the plurality of combustion chambers, the exhaust air system having an exhaust air conduit;
an intake air system in fluid communication with the plurality of combustion chambers, the intake air system having an intake air conduit having a inner diameter defining a intake air flow path, and an intake air compressing device;
a CGI system extending between the exhaust air system and the intake air system, the CGI system is connected to the intake air system upstream of the intake air compressing device, the CGI system includes a CGI injector having a CGI injector valve, an CGI conduit defining a clean gas flow path, the CGI conduit being disposed within the intake air conduit, the CGI conduit includes an open end portion having an inner surface and an outer surface, the outer surface having a substantially less diameter than the inner diameter of the intake air conduit and the open end portion being formed to restrict the intake air flow; and
an ECM operatively coupled to the internal combustion engine.

12. The engine of claim 11, wherein the CGI injector valve includes an actuating device, a bypass member positioned concentrically with the CGI conduit and a shaft connecting the actuating device and the bypass member.

13. The engine of claim 12, wherein the ECM is in communication with the CGI injector valve, the ECM operatively controls the CGI injector valve in response from a signal received from at least one operating parameter of the internal combustion engine to vary the amount to clean gas being introduced into the intake air system.

14. The engine of claim 13, wherein the ECM is operatively coupled to the actuator.

15. The engine of claim 12, wherein the bypass member is a butterfly valve.

16. The engine of claim 11, wherein the CGI conduit includes a bent portion.

17. The engine of claim 16, wherein the CGI conduit includes a turning vane disposed within the bent portion, the turning vane being positioned to divide the clean gas flow into a first flow path and a second flow path.

18. The engine of claim 11, wherein the outer surface of the open end portion has a smooth transition.

19. The engine of claim 18, wherein the smooth transition of the open end portion is substantially a bell mouth shape.

20. The engine of claim 11, wherein the inner surface of the open end portion is formed to have a variable diameter.

21. The engine of claim 11, wherein the inner surface of the open end portion is formed to maintain a constant wall thickness.
